(19) United States
(12) Patent Application Publication
(10) Pub. No.: US 2006/0268922 A1
(43) Pub. Date: Nov. 30, 2006

(54) Apparatus and method for channel allocation in a wireless local area network mesh communication system

(75) Inventors: Sung-Won Lee, Seoul (KR); Rakesh Taori, Suwon-si (KR); Jun-Seo Lee, Seoul (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/431,607

(22) Filed: May 11, 2006

Related U.S. Application Data
(60) Provisional application No. 60/680,532, filed on May 13, 2005.

(30) Foreign Application Priority Data
Apr. 17, 2006 (KR) 2006-34720

(51) Int. Cl. H04J 3/16

(52) U.S. Cl. 370/437

(57) ABSTRACT

An apparatus and a method are provided in a wireless local area network mesh communication system having one wireless interface and multi-channels for improving the performance of the WLAN mesh communication system. A transmitter and a receiver are set to use different channels respectively. A first channel is assigned as a dedicated channel for transmitting data frames and a second channel is assigned as a common channel which receives a control frame, while transmitting the data frames through the first channel. Thus, the control frame is received, while transmitting the data frames, to obtain information relating to the channels which are not already in use and to effectively use the channels, thereby improving the capacity of the network.

### CROSS-REFERENCE TO RELATED APPLICATIONS

This application claims the benefit under 35 U.S.C. § 119(a) of U.S. Provisional Application filed with the U.S. Patent Office on May 13, 2005 and assigned Ser. No. U.S. 60/680,532, and of Korean Patent Application filed with the Korean Intellectual Property Office on Apr. 17, 2006 and assigned Ser. No 2006-34720, the entire disclosure of both of which are hereby incorporated by reference.

### BACKGROUND OF THE INVENTION

1. Field of the Invention

The present invention relates to an apparatus and method for channel allocation in a Wireless Local Area Network (WLAN) mesh communication system. More particularly, the present invention relates to an apparatus and method for channel allocation in a WLAN mesh communication system which uses multi-channels.

2. Description of the Related Art

In general, research for the WLAN communication system has been actively advanced according to the Institute of Electrical and Electronics Engineer (IEEE) 802.11 standards. From among IEEE 802.11 standards, research for the IEEE 802.11s is being actively progressed, which does not require a cable connection between Access Points (APs). The WLAN communication system defined in the IEEE 802.11s standard is especially called “WLAN mesh communication system,” which can be more easily installed and maintained than the other conventional WLAN communication systems defined in other IEEE 802.11 standards. Hereinafter, a structure of a conventional WLAN mesh communication system will be described with reference to FIG. 1.

FIG. 1 is a schematic view illustrating a structure of a conventional WLAN mesh communication system.

Referring to FIG. 1, the WLAN mesh communication system includes a plurality of stations (hereinafter, referred to as STA) 111 and 113, a plurality of Mesh Points (hereinafter, referred to as MPs) 115 and 117, and a plurality of Mesh Access Points (hereinafter, referred to as MAPs) 119 and 121. The MPs 115 and 117 support a mesh service. The MAPs 119 and 121 are a special type of MPs, which provide an AP service as well as the mesh service.

Further, the WLAN mesh communication system supports the multi-channel structure. Thus, the MPs may selectively use one channel of two or more channels for communication between the MPs. For the current WLAN mesh communication system, however, the number of channels for use between the MPs for the support of the multi-channel structure is defined, and the same channel is set for a transmitter and a receiver. However, a specific channel allocation has not yet been considered for the current WLAN mesh communication system. Therefore, it is necessary to arrange a solution for channel allocation for the transmitter and the receiver in order to support the multi-channel structure in the WLAN mesh communication system.

### SUMMARY OF THE INVENTION

An aspect of exemplary embodiments of the present invention is to address at least the above problems and/or disadvantages and to provide at least the advantages described below. Accordingly, an aspect of exemplary embodiments of the present invention is to provide an apparatus and method for channel allocation for a transmitter and a receiver in a multi-channel wireless local area network mesh communication system having one wireless interface.

Another object of exemplary embodiments of the present invention is to provide an apparatus and method for channel allocation, which can receive a control frame through a common channel while transmitting data frame through a dedicated channel in the WLAN mesh communication system.

In order to accomplish these objects, according to an aspect of exemplary embodiments of the present invention, there is provided an apparatus for assigning channels in a wireless local network mesh communication system, in which mesh points are assigned a first channel as a dedicated channel to transmit data frames and a second channel as a common channel through which a control frame is received while transmitting data frames through the first channel.

In order to accomplish these objects, according to another aspect of exemplary embodiments of the present invention, there is provided a method for assigning channels in a wireless local area network mesh communication system, in which a first channel is assigned as a dedicated channel for transmitting data frames and a second channel is assigned as a common channel for receiving a control frame while transmitting the data frames through the first channel.

### BRIEF DESCRIPTION OF THE DRAWINGS

The above and other objects, features, and advantages of certain exemplary embodiments of the present invention will be more apparent from the following detailed description taken in conjunction with the accompanying drawings, in which:

FIG. 1 is a schematic view illustrating the structure of the conventional wireless local area network mesh communication system; and

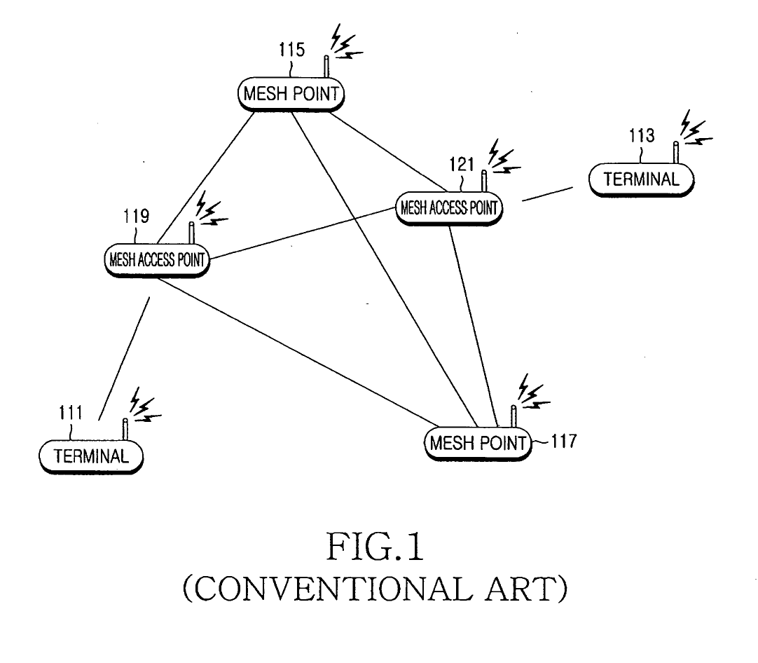

FIG. 2 is a schematic view illustrating allocation of transmission channel and reception channel in a wireless local area network mesh communication system according to an exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the embodiments of the invention. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

In certain exemplary embodiments of the present invention, channels are assigned to a transmitter and a receiver in a wireless local area network (WLAN) mesh communication system. For example, channel allocation is implemented for the transmitter and the receiver in the WLAN mesh communication system using multi-channels, in which a control frame can be received through a common channel while data frames are transmitted through a dedicated channel. In an exemplary implementation, the WLAN mesh communication system follows the provisions relating to IEEE 802.11s.

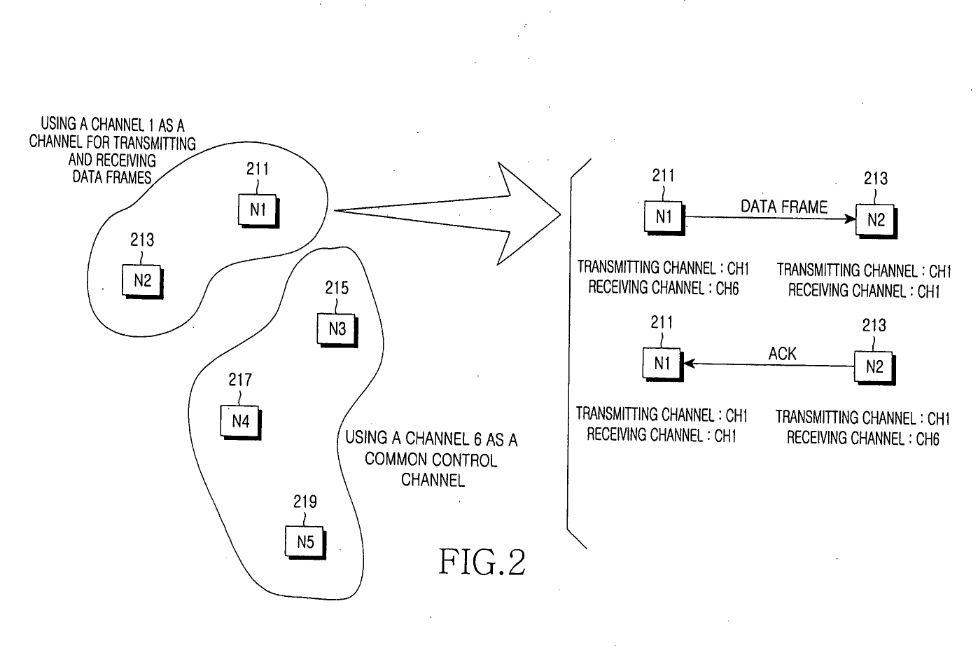

FIG. 2 is a schematic view illustrating an assignment of transmitting channels and receiving channels in a WLAN mesh communication system according to an exemplary embodiment of the present invention.

Referring to FIG. 2, the WLAN mesh communication system includes a plurality of mesh points (MPs), which include N1 211, N2 213, N3 215, N4 217, and N5 219. It is assumed that N1 211 and N2 213 use channel No. 1 (CH1) as a dedicated channel for transmitting data frames, while N3 215, N4 217 and N5 219 use channel No. 6 (CH6) as the common channel.

The WLAN mesh communication system transmits through the common channel the control frame including use information with respect to the multi-channels which are used in the WLAN mesh communication system. As the WLAN mesh communication system transmits the control frames through the common channel, the plurality of MPs can control the usage of the multi-channels. However, in the current WLAN mesh communication system, the number of channels for use between the MPs for the support of the multi-channel structure is defined, and the same channel is set for a transmitter and a receiver.

Therefore, in an exemplary embodiment of the present invention, transmitting and receiving channels are assigned in the WLAN mesh communication system, which will be described in detail with reference to FIG. 2.

First, the transmission of data frames through channel No. 1 from N1 211 to N2 213 will be described.

N1 211 transmits the data frames through channel No. 1 to N2 213, as described above. In the conventional WLAN mesh communication system, after setting up a transmitting channel frequency and a receiving channel frequency to be identical with each other, the MP transmits the data frames through the transmitting channel, that its, the dedicated channel. In an exemplary implementation, since a signal is not substantially received through the receiving channel, the receiving channel receives nothing. On the other hand, according to an exemplary embodiment of the present invention, the WLAN mesh communication system supports the use of a common channel so that N1 211 can receive the control frames through channel No. 6 while transmitting the data frame through channel No. 1.

Meanwhile, N2 213 has the receiving channel frequency set to channel No. 1 in order to receive the data frame, so that both transmitting channel frequency and receiving channel frequency are set to identical channel No. 1.

Second, the transmission of the dedicated control frame through channel No. 1 in N2 213 will be described below.

As described above, N2 213 which receives the data frames transmitted from N1 211 transmits the dedicated control frame, which includes acknowledgement information to acknowledge the reception of the data frame, to N1 211 through channel No. 1. In an exemplary implementation, N2 213 sets the transmitting channel frequency to channel No. 1 while setting the receiving channel frequency to channel No. 6, thereby receiving the control frame.

On the other hand, since N1 211 sets the receiving channel frequency to channel No. 1 in order to receive the dedicated control frame, both transmitting channel frequency and receiving channel frequency are set to the same channel No. 1.

According to exemplary embodiments of the present invention as described above, the WLAN mesh communication system supporting the multi-channels can receive a control signal for the common channel signals while transmitting the data frames, thereby obtaining channel assignment information to be used for setting the multi-channels. Furthermore, the WLAN mesh communication system effectively uses channels, which are not in use yet, by utilizing the obtained channel assignment information, thereby improving the total capacity of the WLAN mesh communication system.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A method for assigning channels in a wireless local area network mesh communication system, the method comprising the steps of:
assigning a first channel as a dedicated channel for transmitting data frames; and
assigning a second channel as a common channel for receiving a control frame while transmitting the data frames through the first channel.

2. The method as claimed in claim 1, wherein a frequency of the first channel and a frequency of the second channel are different.

3. A method for assigning channels in a wireless local area network mesh communication system, the method comprising the steps of:
assigning a first channel as a dedicated channel for transmitting a dedicated control frame comprising acknowledgement information to acknowledge a reception of data frames; and
assigning a second channel as a common channel for receiving a control frame while transmitting the dedicated control frame through the first channel.

4. The method as claimed in claim 3, wherein a frequency of the first channel and a frequency of the second channel are different.

5. An apparatus for assigning channels in a wireless local network mesh communication system, the apparatus comprising
mesh points for assigning a first channel as a dedicated channel to transmit data frames, and a second channel as a common channel to receive a control frame while transmitting data frames through the first channel.

6. The apparatus as claimed in claim 5, wherein a frequency of the first channel and a frequency of the second channel are different.

7. An apparatus for assigning channels in a wireless local area network mesh communication system, the apparatus comprising
mesh points for assigning a first channel as a dedicated channel to transmit a dedicated control frame comprising acknowledge information to acknowledge a reception of data frames, and a second channel as a common channel to receive a control frame while transmitting the dedicated control frame through the first channel.

8. The apparatus as claimed in claim 7, wherein a frequency of the first channel and a frequency of the second channel are different.
